(19) United States
(12) Patent Application Publication
(10) Pub. No.: US 2026/0210138 A1
(43) Pub. Date: Jul. 23, 2026

(54) A REBAR WIRE TYING DEVICE WITH BLANK FIRE RESET FUNCTION

(71) Applicant: HUSQVARNA AB, Huskvarna (SE)

(72) Inventors: Jonas SUNDMARK, Huskvarna (SE); Jonas ERIKSSON, Huskvarna (SE)

(21) Appl. No.: 19/138,881

(22) PCT Filed: Dec. 11, 2023
(86) PCT No.: PCT/EP2023/085041

§ 371 Date: Jun. 13, 2025

(30) Foreign Application Priority Data
Dec. 15, 2022 (SE) 2251465-7

(51) Int. Cl. E04G 21/12; B21F 23/00

(52) U.S. Cl. CPC E04G 21/123; B21F 23/005

(57) ABSTRACT

A wire tying device (100) comprising a wire feed mechanism (110) arranged to feed out a length of wire (210) around two or more elongated objects, a wire receiver mechanism (120) arranged to receive and to hold the fed-out wire (210), and a control unit (170) arranged to control the wire feed mechanism (110) and the wire receiver mechanism (120) to tie a wire knot around the two or more elongated objects, where the control unit (170) is arranged to detect a blank fire condition in case no elongated objects are enclosed by the wire (210) fed out from the wire feed mechanism (110) and held by the wire receiver mechanism (120), where the control unit (170), in response to detecting a blank fire condition, is arranged to control the wire receiver mechanism (120) to release the held wire (210) and to control the wire feed mechanism (110) to retract the fed-out length of wire (210).

### TECHNICAL FIELD

The present disclosure relates to wire tying devices for tying reinforcement bars (rebars) together to form a rebar structure for reinforcing, e.g., concrete and other solidifiable materials.

### BACKGROUND

Concrete is strong under compression but often has relatively weak tensile strength. Reinforcing bars, or rebars, are therefore often used to strengthen concrete structures, where they significantly increase the tensile strength of the concrete.

The most common type of rebar is carbon steel, typically consisting of hot-rolled round bars with deformation patterns. Other types include stainless steel bars, and composite bars made of glass fibre, carbon fibre, or basalt fibre. The steel reinforcing bars may also be coated in an epoxy resin designed to resist the effects of corrosion mostly in saltwater environments, but also in land-based constructions.

The rebar elements are normally connected into a rebar structure or lattice by tying the elements together with steel wire. Due to the large number of connection points between rebar elements in a larger rebar structure, it is desired to automate the wire tying. Wire tying devices for this purpose are known. However, there is a continuing need for improved automatic rebar wire tying devices.

### SUMMARY

It is an object of the present disclosure to provide improved automatic wire tying devices. This object is at least in part obtained by a wire tying device comprising a wire feed mechanism arranged to feed out a length of wire around two or more elongated objects, a wire receiver mechanism arranged to receive and to hold the fed-out wire, and a control unit arranged to control the wire feed mechanism and the wire receiver mechanism to tie a wire knot around the two or more elongated objects, such as rebars, electrical wires, and plumbing. The control unit is arranged to detect a blank fire condition in case no elongated objects are enclosed by the wire fed out from the wire feed mechanism and held by the wire receiver mechanism The control unit is also arranged to control the wire receiver mechanism to release the held wire and to control the wire feed mechanism to retract the fed-out length of wire in response to detecting a blank fire condition. This way the fed-out wire is recovered by the wire tying device and can be used in another attempt at tying a wire knot, which is an advantage since it reduces the amount of wire wasted due to blank fire. By recovering the wire in this manner the wire tying device is also reset, i.e., made ready for another attempt at tying a wire knot in a more convenient manner compared to if the failed wire knot had been cut and perhaps in need of manual removal from the wire tying device.

According to some aspects, the control unit is arranged to control the wire feed mechanism to tighten the wire held by the receiver mechanism by retracting the wire. The control unit determines a fed-out length of wire and a retracted length of wire, and detects blank fire condition based at least in part on the determined fed-out length of wire and on the determined retracted length of wire. Thus, the control unit keeps track of how much wire that has been fed out and how much wire that is retracted, and is therefore in a position to determine if elongated objects are present or not in a dependable and cost efficient manner. The control unit may use one or more out of several options for determining the fed-out length of wire and/or the retracted length of wire. The wire tying device may for instance comprise a wire feed sensor arranged to monitor a length of wire fed out and/or retracted by the wire feed mechanism by a measuring wheel biased against the wire. The control unit may also be arranged to determine a length of wire fed out and/or retracted by the wire feed mechanism based on a control signal sent to a wire feed motor of the wire tying device which, e.g., measures an on-time of the feed motor that is correlated with the length of wire fed out or retracted from the feed mechanism. The wire tying device may furthermore comprise a wire end detection sensor arranged in connection to the wire feed mechanism. This way the control unit is in a position to detect an end of the wire being retracted into the wire feed mechanism based on an output signal from the wire end detection sensor. Thus, the control unit may implicitly determine the length of retracted wire, since it knows when it has received the free end of the wire at the feed mechanism part of the wire tying device.

The control unit may also be arranged to detect the blank fire condition based at least in part on an output signal from a proximity sensor. The proximity sensor may comprise any of; a mechanical switch, a capacitive proximity sensor, an electromagnetic proximity sensor, a vision-based proximity sensor, or an electrical conductance sensor. This extra blank fire detection mechanism provides redundancy and improves the reliability of the blank fire detection methods discussed herein.

The control unit may also be arranged to monitor a number of consecutive blank fire condition events, and to cut the fed-out wire after a pre-determined number of consecutive blank fire condition events. This way repeated wire tying failures will not cause weakness in the knot once a successful wire tying attempt is finally achieved.

The control unit in the wire tying device is optionally also arranged to monitor a number of blank fire condition events and a number of successful wire knot tying events, and to store the monitored number of blank fire condition events and the number of successful wire knot tying events in a storage medium of the wire tying device. This data is representative of the performance of the wire knot tying device and can be used for maintenance purposes and general performance monitoring.

The control unit may also be arranged to monitor a number of consecutive blank fire condition events, and to trigger an error signal if the number of consecutive blank fire condition events exceeds a pre-determined number of consecutive blank fire condition events. This way an operator of the wire tying device is made aware of the fact that an unusual amount of failed attempts have been made, and that an investigation into the cause of the attempts may be in order. This feature is particularly useful if the wire tying device is comprised in an autonomous wire tying system where no operator is present in vicinity of the wire tying device, but instead located remote from the wire tying device.

Methods and computer programs are also disclosed herein which are associated with the above-mentioned functions and advantages.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

The present disclosure will now be described in more detail with reference to the appended drawings, where

FIG. 1 shows an example wire tying device,

FIG. 2 illustrates details of a wire tying head of a wire tying device,

FIGS. 3, 4A-B illustrate details of example wire locking mechanisms,

FIGS. 5A-B illustrate example locking mechanisms,

FIGS. 6-9 illustrate a sequence of wire tying operations,

FIGS. 10-11 illustrate a blank fire reset operation,

FIG. 12 schematically illustrates monitoring of a fed-out length of wire,

FIG. 13 illustrates various wire feed monitoring sensors,

FIGS. 14A-B are graphs illustrating details of a blank fire reset operation,

FIGS. 15-16 are flow charts illustrating wire tying operations; and

FIG. 17 illustrates a control unit according to an example realization.

### DETAILED DESCRIPTION

The invention will now be described more fully hereinafter with reference to the accompanying drawings, in which certain aspects of the invention are shown. This invention may, however, be embodied in many different forms and should not be construed as limited to the embodiments and aspects set forth herein; rather, these embodiments are provided by way of example so that this disclosure will be thorough and complete, and will fully convey the scope of the invention to those skilled in the art. Like numbers refer to like elements throughout the description.

It is to be understood that the present invention is not limited to the embodiments described herein and illustrated in the drawings; rather, the skilled person will recognize that many changes and modifications may be made within the scope of the appended claims.

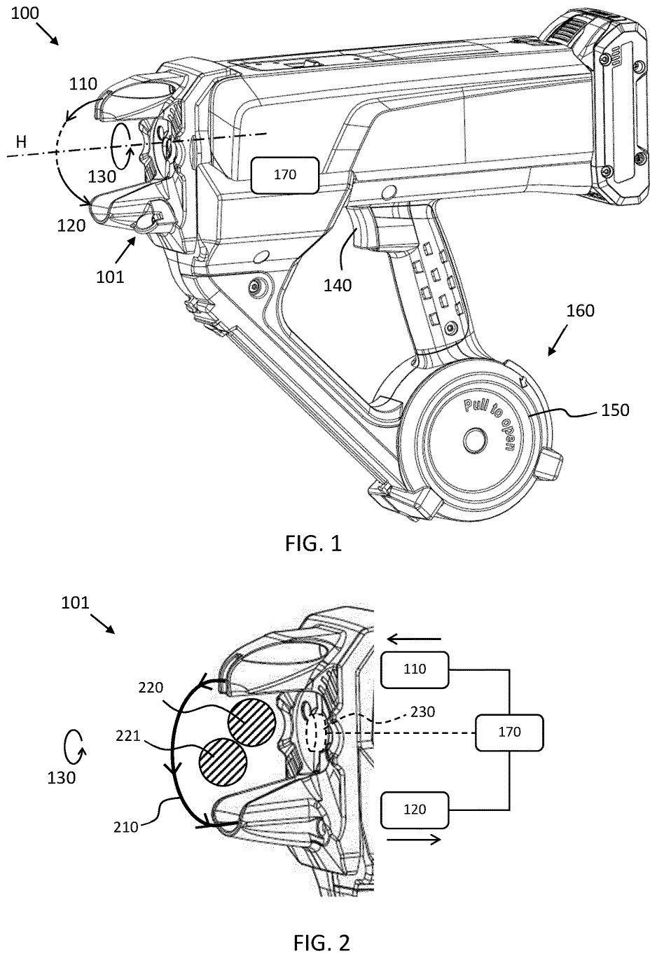

FIG. 1 shows a wire tying device 100 for tying wire knots that secure a rebar structure. FIG. 2 shows some details of the device 100, in particular its tying head 101, which is the part that forms the wire knot on the wire 210. The wire tying device 100 comprises a wire feed mechanism 110 arranged to feed a free end of a wire 210 out from an opening in a tying head 101 of the device. The free end of the wire 210 is the end of the wire which is fed out from the tying head 101 by the feed mechanism 110 and then received back in the tying head by the wire receiver mechanism 120, i.e., the end opposite to the end on the wire spool 150. The wire tying devices described herein are particularly suitable for tying two or more rebars together, but can of course also be used to tie other elongated objects together, such as plumbing and electrical wires. The wire tying devices described herein may also find use in attaching elongated objects to some form of fixed infrastructure.

The wire is preferably rolled prior to being fed out from the wire tying head 101, and therefore assumes an arcuate form due to the rolling inside the tying head 101. EP 2666932 discusses rolling of a wire such that it extends in an arcuate form when exiting the wire tying head 101. Rolling arrangements for rolling rebar tying wire will therefore not be discussed in more detail herein.

The wire 210 extends along an arcuate path to encircle the rebars 220, 221 which are to be tied together, as illustrated in FIG. 2. The free end of the wire 210 is received by the wire receiver mechanism 120, where it is releasably held by a wire locking mechanism which will be discussed in detail below. The wire locking mechanism body comprised in the wire tying head 101 is then brought to rotate 130 about a wire tying head axis H, which rotation forms a knot on the wire 210. The wire tying device 100 is also arranged to cut the wire upon completion of the knot, thereby releasing the wire tying device 100 from the knot to allow formation of a new knot. This way a series of wire knots may be formed in rapid succession. Any stops in the operation of the device 100 due, e.g., to a need for manual intervention of some kind is highly undesired as it hampers the rate of knot production and therefore also the rate of the rebar tying task.

A control unit 170 is arranged to control the operations performed by the different components of the wire tying device 100, such as actuation of the feed mechanism 110 and actuation of the receiver mechanism 120. The control operations performed by the control unit 170 may comprise operating one or more feed motors and actuators of the device 100, such as solenoid devices configured to engage control arms and levers. The control unit 170 may operate at least partly based on input signals from one or more sensors. FIG. 2 schematically illustrates an optional rebar detection sensor 230 connected to the control unit 170. Examples of how this rebar detection sensor 230 can be realized will be discussed in more detail below. Other sensors will be discussed in more detail below in connection to FIG. 13.

The wire tying operation by the device 100 is automatically executed by the control unit 170 in a sequence of steps initiated by actuation of the trigger 140. An amount of wire is stored on a spool 150 comprised in a spool compartment 160 of the wire tying device. Thus, the wire tying device 100 allows for conveniently and efficiently tying together rebar structures.

A problem when tying rebars together is that the device 100 may be prematurely or otherwise erroneously triggered by a user, referred herein as a blank fire event. During a blank fire condition no rebars are present in connection to the tying head 101 when the trigger 140 is actuated, and the knot operation will therefore fail. Machines are known which are configured to detect when this happens and cut the length of fed-out wire in response to detecting the blank fire condition. To cut the wire in response to detecting a blank fire event is, however, a waste of wire material which is undesired. The operator normally also has to manually clear the cut wire from the tying head 101, which hampers the production rate and causes inconvenience to the operator.

Instead of cutting the wire in response to detecting a blank fire event, it is proposed herein to release the wire at the wire receiver mechanism 120 in response to detecting a blank fire condition, and subsequently to retract the fed-out portion of wire back into the wire feed mechanism 110 in order to reset the device such that a new knot forming operation may be triggered without delay. In other words, there is disclosed herein a rebar wire tying device 100 comprising a wire feed mechanism 110 arranged to feed out a length of wire 210 around two or more rebars 220, 221, a wire receiver mechanism 120 arranged to receive and to hold the fed-out wire 210, and a control unit 170 arranged to control the wire feed mechanism 110 and the wire receiver mechanism 120 to tie a wire knot around the rebars. The control unit 170 is arranged to detect a blank fire condition in case no rebars are enclosed by the wire 210 fed out from the wire feed mechanism 110 and held by the wire receiver mechanism 120. The control unit 170 is also arranged to control the wire receiver mechanism 120 to release the held wire 210 and to control the wire feed mechanism 110 to retract the fed-out length of wire 210 in response to detecting a blank fire condition, thereby resetting the rebar wire tying device 100 and placing the device in condition to start a new wire knot tying operation.

This way the fed-out wire can be re-used for a new knot since it is retracted back into the device 100 instead of being cut away. There is no need for manual clearing of the different mechanisms of the device 100 following retraction since the device is essentially reset and ready for another knotting operation following the retraction of the wire. The operations performed in response to detection of a blank fire event effectively resets the device 100 in a short period of time and readies the device for another attempt at tying a knot in a convenient and efficient manner.

It is noted that, even if the wire is successfully retracted back onto the spool 150 after each blank fire event, there may be some extra wear on the wire due to the holding by the wire receiver mechanism 120 and the tightening of the wire by the wire feed mechanism 110 during an unsuccessful attempt to tie a knot. It may be beneficial to discard a portion of wire after a number of consecutive failed knotting attempts. Consequently, the control unit 170 is optionally arranged to monitor a number of consecutive detected blank fire condition events (blank fire events with no successful knotting operation performed in-between), and to cut the fed-out wire after a pre-determined number of consecutive blank fire condition events instead of retracting the wire back into the device. The predetermined threshold for cutting the fed-out length of wire in order to extrude a fresh portion of wire may be set between 5-10 consecutive blank fire events or so.

The control unit 170 may also be arranged to monitor the number of consecutive blank fire condition events without successful knot operations in-between, and to trigger generation of an error signal, e.g., by a display device, light emitting diode (LED), and/or buzzer on the device 100, if the number of detected consecutive blank fire condition events exceeds a pre-determined number of consecutive blank fire condition events. A wireless signal may also be sent to an external control unit as part of the error signal. The operator is then notified that something is amiss, either that the device 100 is malfunctioning or that the operator is using the device 100 in the wrong way. The control unit 170 may of course also trigger generation of a notification signal, such as a buzzer, light, or message on a display, each time a blank fire condition is detected, such that the operator becomes aware of the fact.

The control unit 170 may also be arranged to repeatedly actuate a solenoid of the wire locking mechanism in response to the generated error signal or as part of the generated error signal.

The control unit 170 is optionally arranged to monitor the number of blank fire condition events and also the number of successful wire knot tying events, and to store the monitored number of blank fire condition events and the number of successful wire knot tying events in a storage medium of the wire tying device. This storage medium will be discussed in more detail below in connection to FIG. 17. The data obtained in this manner can be used for performance evaluation of the wire tying device.

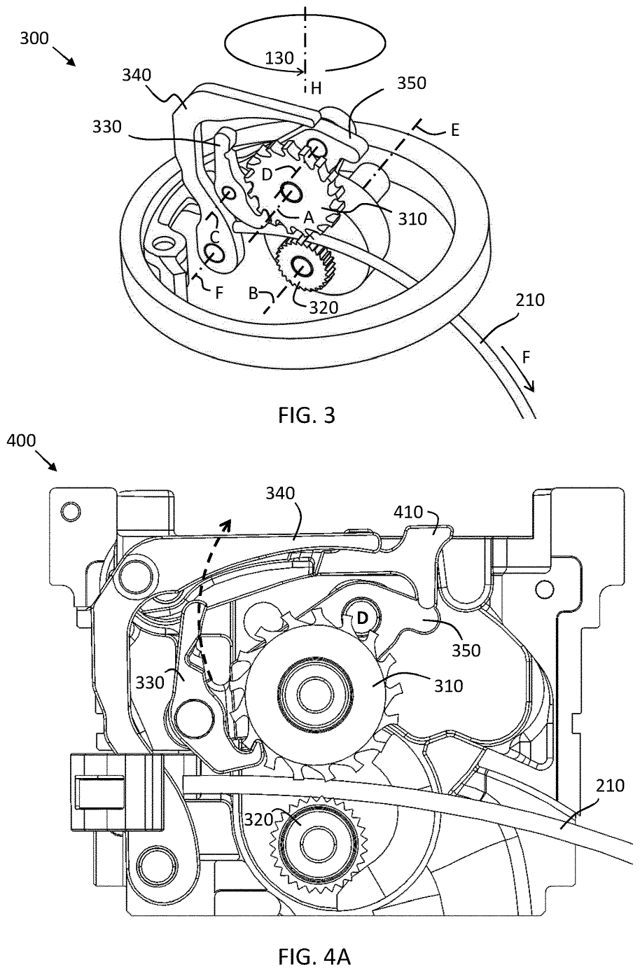

FIG. 3 illustrates an example wire locking mechanism 300 for a rebar wire tying device such as the device 100. The wire locking device 300 forms part of the wire receiver mechanism 120 comprised in the tying head 101. It receives the free end of the wire 210 and then holds the free end of the wire during formation of the knot. In this example the entire wire locking mechanism 300 is arranged to rotate 130 about the tying head axis H to form the knot. It is appreciated that this is one example of a wire locking mechanism. The techniques discussed herein are particularly suitable for use with this type of rotatable mechanism, but the techniques are in no way limited to this exact mechanism. Rather, it is to be understood that the blank fire detection and reset functions discussed herein can be used with a wide variety of locking mechanisms.

The example locking mechanism 300 in FIG. 3 comprises a holding member 310 and a counter-holding member 320 arranged to receive the free end of a wire 210 and to engage respective sides of the wire 210 to releasably hold the wire in a locking position. Normally, the holding member 310 and the counter-holding member 320 are arranged to engage opposite sides of the wire 210, but this is not necessary as the holding member may engage the wire at an angle with respect to the counter-holding member. The holding members 310, 320 are rotatably supported about respective axes A, B.

The holding member 310 and the counter-holding member 320 are here exemplified by toothed wheels. It is, however, appreciated that other holding members can be used, such as friction pads.

To releasably hold the wire 210 means that the holding force exerted on the wire by the locking mechanism 300 can be reduced at a pre-determined time instant during the tying process, whereby the wire is released from the wire locking mechanism 300.

The holding member 310 is supported on a first end of an excentre arm 350. The excentre arm 350 is rotatably supported about axis D, which means that it may rotate such that the holding members 310, 320 are brought into contact with the wire 210, and also that it may rotate such that the holding members become separated from each other. The holding member 310 is arranged distanced from the excentre arm center of rotation. This means that the holding force exerted on the wire 210 develops as the excentre arm 350 is rotated about the excentre arm center of rotation.

The excentre arm 350 together with the holding member 310 and the counter-holding member 320 forms an excentre locking mechanism which holds the wire in response to a pull force F exerted by the wire feed mechanism as the wire is retracted into the wire feed mechanism during tightening of the knot.

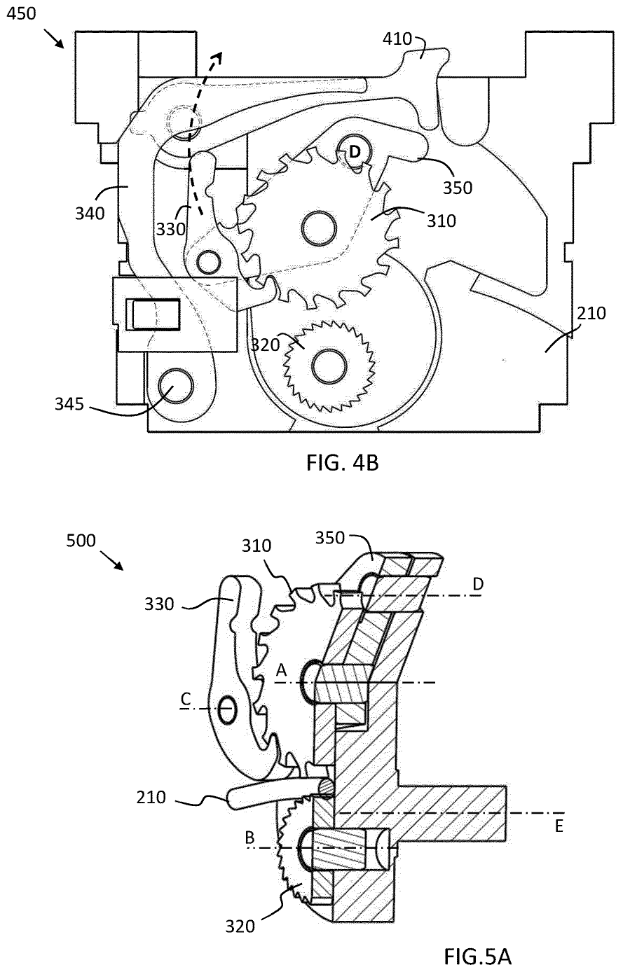

The example wire locking mechanism 300 in FIG. 3 also comprises a catch arrangement 330 configured to lock the holding member 310 when in the locking position illustrated in FIG. 3. The catch arrangement 330 is rotatably supported on the excentre arm 350 about axis C and also rotates together with the holding member 310 about axis D. The catch arrangement may be operated by a separate actuator or by a fixed control arm, as will be discussed in more detail below in connection to FIGS. 4A and 4B. The catch arrangement 330 may be spring loaded towards a position in which it locks the holding member 310, i.e., a position where it prevents rotation of the holding member 310 about axis A.

With continued reference to FIG. 3, an opening between the holding member 310 and the counter-holding member 320 can be created by rotating the excentre arm 350 about axis D to separate the holding member 310 from the counter-holding member 320. The wire 210 can then be received between the holding member and the counter-holding member more easily.

The different components of the wire locking mechanism 300 may be spring loaded so as to be biased towards respective default positions. The spring biasing may be achieved using, e.g., torsion springs. For instance, the excentre arm 350 may be spring loaded towards the locking position and the catch arrangement 330 may be spring loaded towards a locking contact with the holding member 310.

FIG. 4A illustrates an example wire locking mechanism 400 with an actuator 410 that is controllable from the control unit 170, e.g., via a solenoid, and arranged to engage the upper end of the excentre arm 350 to cause a rotation of the excentre arm (illustrated by the dashed arrow in FIG. 4A) which separates the holding member 310 from the counter-holding member 320. As the actuator 410 engages the excentre arm 350, the catch arrangement 330 engages a control arm 340 which induces a rotation of the catch about the axis C to release the catch. The control arm 340 may also be arranged separately controllable from the control unit 170 as illustrated in FIG. 4B, where the control arm 340 is rotatably mounted about shaft 345 and controlled from the control unit 170 by a separate actuator, such as a second solenoid device.

FIG. 5A illustrates a cross-sectional view of an example locking mechanism 500. Axis A is the axis about which the holding member 310 rotates. Axis B is the axis about which the counter-holding member 320 rotates. Axis C is the axis about which the catch mechanism 330 rotates. Axis D is the axis about which the excentre arm 350 rotates. A rotation of the excentre arm 350 also rotates the holding member 310 and the catch mechanism 330 since these are supported by the excentre arm 350. The whole locking mechanism then rotates about axis E.

FIG. 5B illustrates another example locking mechanism 550 similar to the example locking mechanism 500 in FIG. 5A. In this mechanism the holding member 310 and the counter-holding member 320 are supported on their respective axles by ball bearings 560, 570. Holding members and counter holding members of this kind is generally applicable in locking mechanisms for wire tying devices. Thus, locking mechanisms are disclosed herein that comprise a holding member 310 and a counter-holding member 320 arranged to engage a wire 210 as discussed herein, where the holding member 310 and/or the counter-holding member 320 are rotatably supported about respective axes by ball bearings.

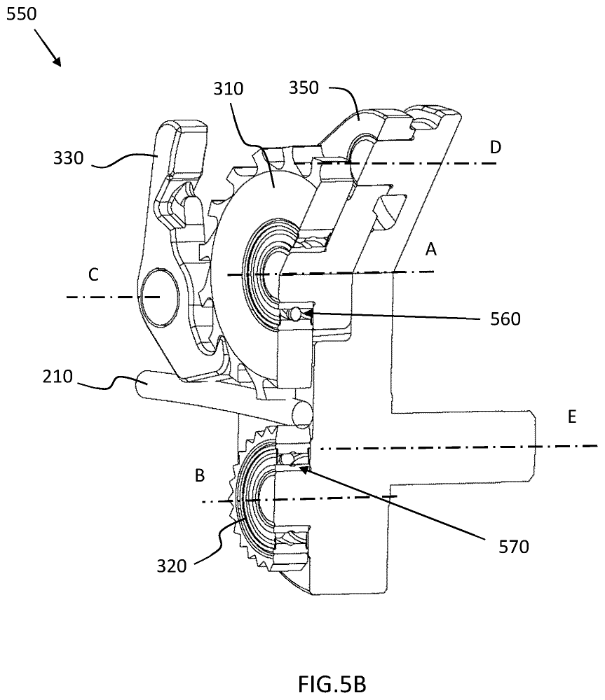

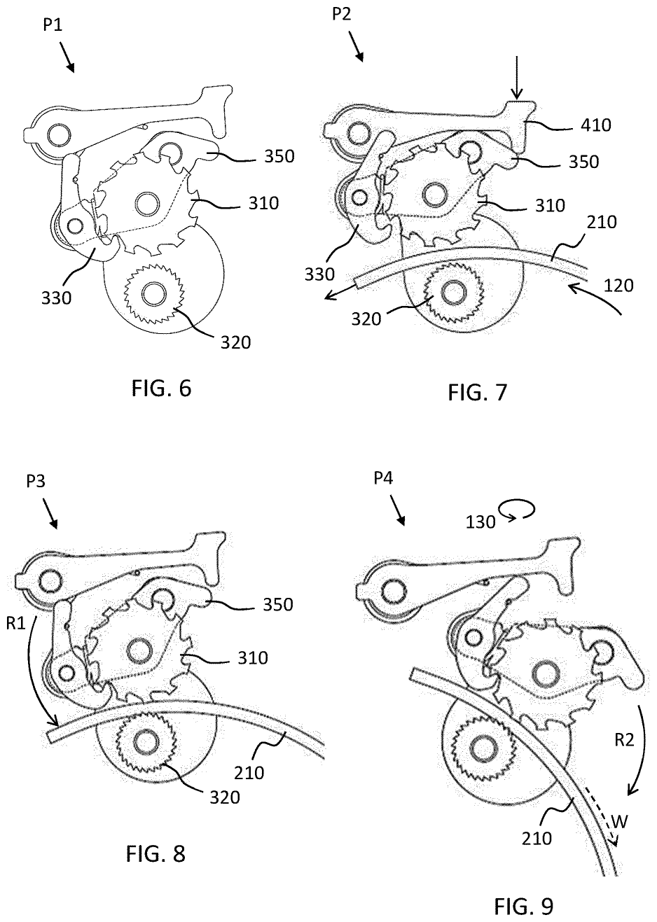

FIGS. 6-9 illustrate an example wire tying operation by the device 100. The control unit 170 is configured to transition the wire locking mechanism from a neutral position P1 illustrated in FIG. 6 into a wire infeed mode position P2 as illustrated in FIG. 7 by controlling the actuator 410 to engage the upper end of the excentre arm 350 which separates the holding member 310 from the counter-holding member 320. As discussed above, the wire locking mechanism may be spring-loaded or otherwise biased towards the neutral position P1 shown in FIG. 6 where the excentre arm 350 is rotated to separate the holding member 310 from the counter-holding member 320, and the catch arrangement is in locking contact with the first toothed wheel. The control unit 170 then controls the wire feed mechanism 110 to feed a wire into the wire locking mechanism. FIG. 7 illustrates the wire locking mechanism in wire-infeed mode P2. The excentre arm 350 is now rotated by means of the actuator 410. Note that the catch arrangement 330 is released when the locking mechanism is in the wire-infeed mode P2. This catch release can be achieved, e.g., by means of the control arm 340 discussed above, which may be either passive (as in FIG. 4A) or active (as in FIG. 4B). In this example the wire 210 is able to enter between the holding member 310 and the counter-holding member 320 easily due to the free-rolling state of the toothed wheels in the wire-infeed mode P2.

The control unit 170 then transitions the wire locking mechanism from the wire infeed mode P2 into the locking position mode P3 illustrated in FIG. 8, where the wire 210 is held between the holding member 310 and the counter-holding member 320. To transition the locking mechanism into the locking position P3, the excentre arm 350 is caused to rotate in direction R1 about axis D.

The entire locking mechanism then rotates in direction R2 in response to a pull force on the wire 210, as illustrated in FIG. 9, as the wire is being tightened about the rebars. The pull force on the wire is generated by running the wire feed mechanism 110 of the wire tying device in reverse. This rotation R2 helps ensure that the knot is tight. This rotated mode P4 is illustrated in FIG. 9.

The control unit 170 then twists 130 the locking mechanism body about the wire tying head axis H to tie a knot on the wire 210 and, at a pre-determined angle of rotation, the wire is released from the wire locking mechanism and cut at the feed end.

The control unit 170 is thus arranged to control the wire feed mechanism 110 to tighten the wire 210 held by the receiver mechanism 120 by retracting the wire 210 as illustrated by the dashed arrow W in FIG. 9. The control unit 170 may then at the same time determine a fed-out length l1 of wire 210 and a retracted length of wire l2 and detect the blank fire condition based at least in part on the determined fed-out length l1 of wire 210 and on the determined retracted length of wire l2. The retracted length of wire can be measured from the start of wire retraction to a point in time when there is sufficient resistance in the wire to stop retraction. The end of the retraction phase can be determined based on a torque output from the retraction mechanism, from a cessation of retraction due to the wire resisting further retraction, or from some other form of sensor device configured to determine when no more wire can be retracted by the wire retraction mechanism. This detection of blank fire condition is made possible since the rebars, if caught by the wire, will take up some space and prevent retraction of the wire. Hence, the wire can be retracted further in case of a blank fire condition than it otherwise can if rebars are caught by the wire loop. Thus, by comparing the difference between the fed-out length l1 (mode P2) and the retracted length of wire l2 (mode P4) to a predetermined threshold T, the control unit 170 can detect a blank fire condition. For example, a blank fire condition can be detected if

$${l}_{1} - {l}_{2} \leq T$$

where l1 is the distance the wire 210 is initially fed out from the wire feed mechanism 110, l2 is the length of wire retracted during tensioning of the wire 210, and T is the predetermined threshold. Blank fire condition is, essentially, declared if l₂ is unusually large considering l₁ and the geometry of the wire tying device. The control unit performs this detection 170 without additional sensors, which is an advantage. The threshold T may, e.g., be selected with a margin compared to the theoretical maximum distance that the wire can be retracted when there are no objects to tie the wire about. The threshold T can also be selected based on a geometry of the wire tying device, such that blank fire detection is declared when the wire has been retracted sufficiently far that no objects can be present in the wire know tying position of the wire tying device.

The control unit 170 can also be arranged to detect a blank fire condition based at least in part on an output signal from a proximity sensor such as the rebar detection sensor 230 illustrated in FIG. 2. A proximity sensor 230 for detecting presence of elongated objects such as rebars may generally comprise any of; a mechanical switch, a capacitive proximity sensor, an electromagnetic proximity sensor, a vision-based proximity sensor, and an electrical conductance sensor.

A mechanical switch can be arranged in connection to the tying head 101 as illustrated in FIG. 2. The switch is actuated when the tying head 101 is pressed against a rebar. If the trigger 140 is pulled without rebars present, as sensed by the mechanical switch, then a blank fire event can be detected by the control unit 170.

A capacitive proximity sensor can be used by the control unit 170 in a similar manner. The capacitive proximity sensor detects the presence of a rebar element and the control unit 170 can declare a blank fire condition in case no rebar element is detected by the capacitive proximity sensor.

An electromagnetic proximity sensor, i.e., a radar device, or a vision-based proximity sensor device can of course also be used.

With reference to FIG. 13, which will be discussed in more detail below, the rebar wire tying device 100 may also comprise a measuring device 1310 that is arranged to monitor a length of wire fed out and/or retracted by the wire feed mechanism 110. The measuring device may, e.g., comprise a measuring wheel arranged biased against the wire 210 to rotate as the wire moves past the wire feed sensor. The measuring device may also comprise a vibration sensor or a capacitive sensor arranged in connection to the wire, which senses a motion by the wire as it moves past the location of the measuring device. The frequency and/or magnitude of vibration can, at least in some cases, be mapped to a wire feed speed and subsequently translated into a length of wire fed out and/or retracted in combination with a timer measuring time of the feed process. The control unit 170 can also be arranged to determine a length of wire fed out and/or retracted by the wire feed mechanism 110 based on a control signal sent to a wire feed motor 1320 of the rebar wire tying device 100. The control signal sent to the wire feed motor 1320 may, e.g., be a feed motor activation signal that can be used to measure extruded length of wire in combination with a timer, assuming a constant feed rate of the motor 1320. Some motors also comprise internal Hall effect sensors or other rotary encoders that allow measuring an amount of extruded or retracted wire.

A wire end detection sensor 1330 can also be arranged in connection to the wire feed mechanism 110. A wire end detection sensor can be realized in many different ways. One example is a sensor with a probe arranged biased against the wire. When the wire end moves past the probe, the probe will move which will trigger generation of the wire end signal to the control unit 170. In this way the control unit 170 can be arranged to detect an end of the wire being retracted into the wire feed mechanism 110 based on an output signal from the wire end detection sensor. This means that the control unit 170 need not keep careful check on the amount of extruded wire in order to perform the blank fire reset operations discussed herein. The control unit may simply extrude and retract wire with some margin during the wire knot tying process, and in case of detecting a blank fire condition retract the wire until the wire end sensor 1330 outputs a signal to the control unit 170 informing the control unit that the end of the free end of the wire has reached the wire feed mechanism 110. One or more sensors can be used in combination by the control unit 170 for increased robustness.

In case the control unit 170 detects a blank fire condition, i.e., in case no rebars have been enclosed by the wire 210 fed out from the wire feed mechanism 110 and held by the wire receiver mechanism 120, the control unit 170 will not perform the rotation 130 to tie a knot and subsequently cut the wire. Instead, the control unit 170 will control the wire receiver mechanism 120 to release the held wire 210 and control the wire feed mechanism 110 to retract the fed-out length of wire 210 back onto the spool 150.

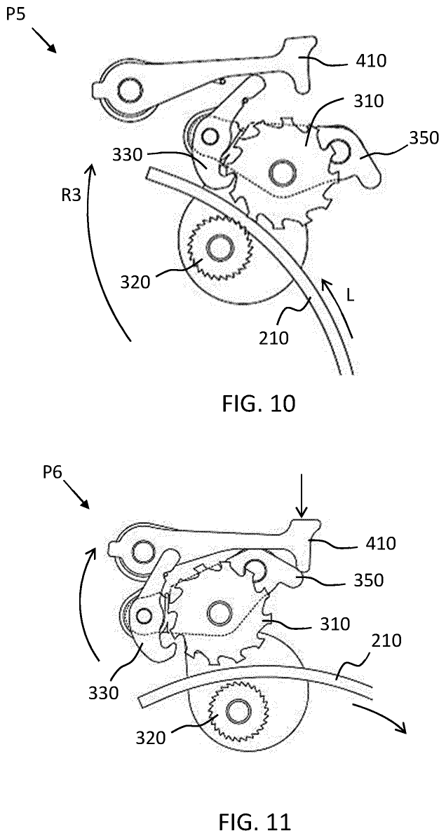

FIG. 10 illustrates operation mode P5 where the wire 210 is fed back out (L) from the feed mechanism in order to reduce longitudinal tension on the wire. This will cause the locking mechanism to rotate back in direction R3 about axis E. By releasing the longitudinal tension in the wire 210 in this manner, the pressure exerted by the holding member 310 and the counter-holding member 320 is reduced due to that the excentre arm no longer strives to apply lateral pressure on the wire at the point of contact between the holding member and the counter-holding member. The holding member 310 and the counter-holding member 320 can then be separated from each other by controlling the actuator 410, which allows the fed-out part of the wire to be retracted by the wire feed mechanism 110, as illustrated by operation mode P6 in FIG. 11.

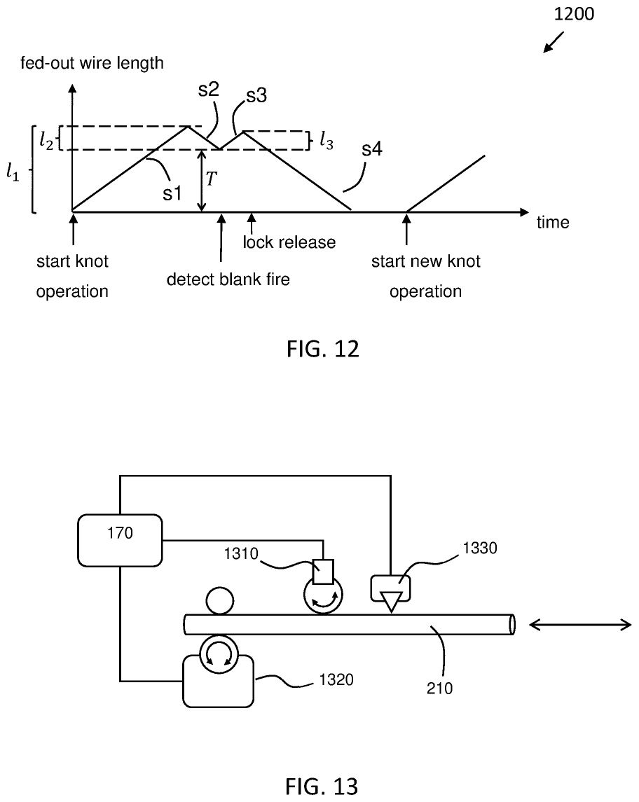

FIG. 12 shows a graph 1200 which schematically illustrates feeding out and retracting a wire during a wire knot tying operation where a blank fire condition occurs. The wire 210 is first fed out (s1) a length l₁ by the wire feed mechanism 110 in order to capture the rebars. Upon being received and held by the wire receiver mechanism 120, the wire is tightened (s2) by the feed mechanism retracting the wire until it is sufficiently tight. In case there are no rebars enclosed by the wire, the retracted distance l₂ will be larger compared to the case that rebars are enclosed by the wire. In case a blank fire condition is detected, then the control unit 170 will control the wire feed mechanism 110 to feed some portion l₃ of wire back out (s3), release the wire locking mechanism, and then retract (s4) the remaining fed-out length of wire back into the wire tying device (of distance l₁−l₂+l₃). Thus, the wire tying device is readied for another attempt at tying a wire knot and may start a new knot operation without significant delay. It is appreciated that the length 13 of the portion of wire fed back out (s3) after blank fire detection can be both longer and shorter than the retracted distance l₂, depending on implementation. An efficient implementation most likely uses a shorter feed-out distance, i.e., l₂>l₃.

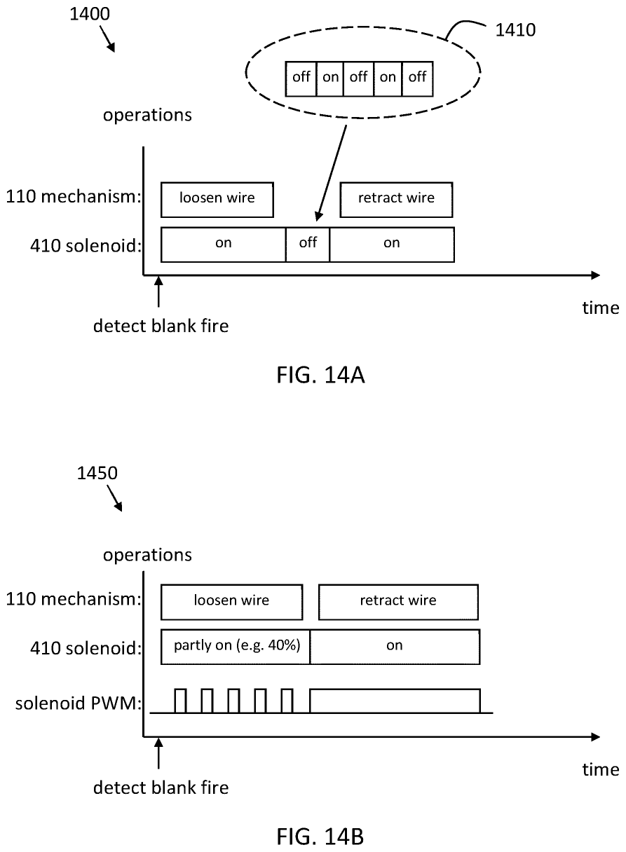

FIG. 14A illustrates example operations 1400 of the feed mechanism 110 and of a solenoid configured to control the actuator 410. The feed mechanism 110 first loosens the wire some in order to reduce the pressure exerted on the wire 210 by the holding and counter-holding members 310, 320. During this loosening, the actuator 410 engages the excentre arm in order to urge the holding member and counter-holding member away from each other to release the wire. The free end of the wire 210 may have gotten stuck in the locking mechanism during the initial stages of the wire tying operation, e.g., due to that the teeth of the holding member 310 or counter-holding member 320 has bitten into the wire 210. Hence, it may be advantageous to flip the solenoid off and then back on a few times 1410 as illustrated in the insert of FIG. 14A, to release the wire from the holding mechanism and reset the catch mechanism, i.e., readying the catch mechanism for another knot tying attempt. The repeated actuation by the solenoid device promotes release of the catch 330 which is an advantage. The repeated actuation by the solenoid device is also likely to be noticed by an operator of the device, thus serving as notification of the ongoing blank fire routine.

FIG. 14B illustrates other example operations 1450 of the feed mechanism 110 and of the solenoid configured to control the actuator 410. In this case the solenoid is only partly activated during the loosening of the wire, and then fully activated during retraction of the wire. A partly activated solenoid can, e.g., be realized by controlling the solenoid using a pulse-width modulated (PWM) feed current having a duty cycle which can be controlled to set the activation level of the solenoid. The partly activated solenoid may be activated at a percentage of full activation force. A suitable value for this activation level may be on the order of 30-60% of full solenoid activation, and preferably about 40% of full solenoid activation. In case the solenoid is controlled using a PWM current, the duty cycle of this PWM current should be around 30-60% and preferably about 40% of full solenoid activation.

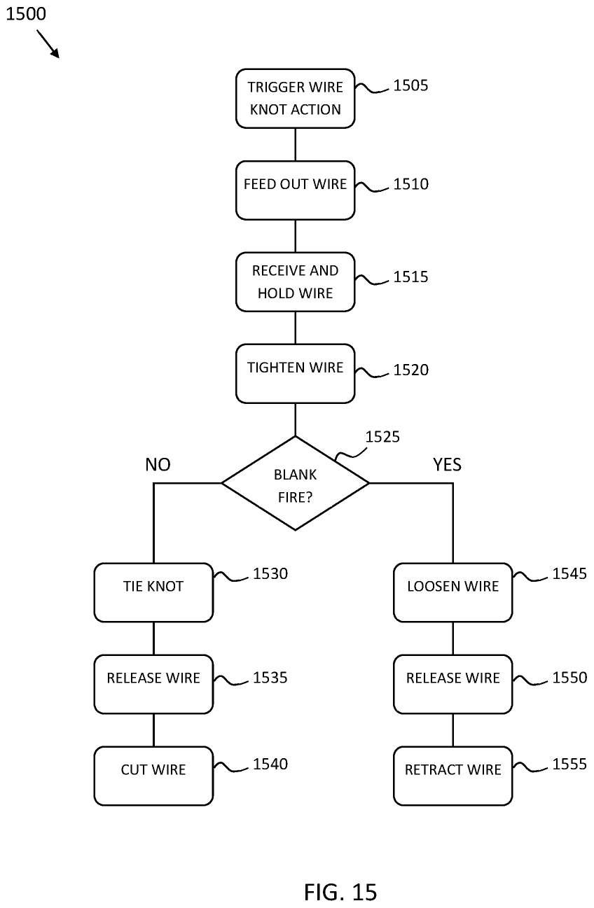

FIG. 15 shows a flow chart 1500 which illustrates a method that summarizes the discussion herein. A user starts the process by triggering 1505 a knot tying process, e.g., using the trigger 150. The feed mechanism 110 then feeds out a portion of wire 1510, optionally keeping track of how much of the wire 210 that has been fed out. The wire 210 doubles back along the arcuate form, as illustrated in FIG. 2, and is received by the wire receiver mechanism 120, where it is also held 1515. Once the wire 210 is received and held by the wire receiver mechanism 120, the feed mechanism 110 starts to tighten the wire 1520 by retracting the wire. The control unit 170 optionally monitors how much wire that is retracted, thus keeping track of how much wire that has been output in total.

Several different techniques for detecting a blank fire condition 1525, i.e., an event where no rebars have been caught by the extruded wire, have been discussed above. A preferred option is to use the wire feed length monitor techniques which just keeps track of how much wire is extruded and how far the wire can be retracted before it starts to resist retraction, but sensor solutions can also be used, as alternative or in combination with the wire length-based techniques.

In case no blank fire condition is detected, then the wire tying device proceeds to finish the knot, i.e., performs the rotation 130 to tie the knot 1530, followed by release of the wire from the locking mechanism 1535 and cutting of the wire 1540 to release the knot from the wire tying device 100.

In case a blank fire condition is detected, then the wire feed mechanism 110 instead loosens the wire again 1545 to reduce the pressure on the locking mechanism, followed by control of the locking mechanism 1550 to release the wire 210, and retraction of the wire 1555 in order to reset the wire tying device in preparation for a new knotting attempt.

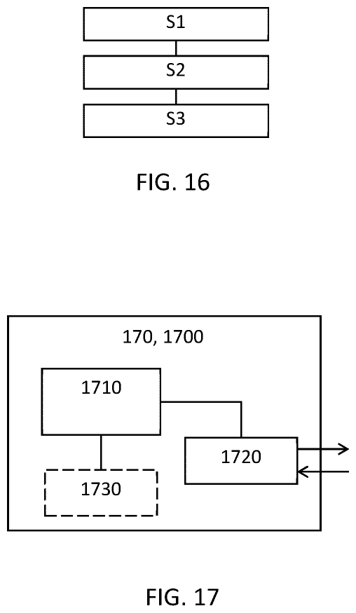

FIG. 16 is a flow chart illustrating a method performed by a control unit 170 in a wire tying device 100, such as the wire tying device discussed above, i.e., a wire tying device 100 which comprises a wire feed mechanism 110 arranged to feed out a length of wire 210 around two or more elongated objects, a wire receiver mechanism 120 arranged to receive and to hold the fed-out wire 210, and a control unit 170 arranged to control the wire feed mechanism 110 and the wire receiver mechanism 120 to tie a wire knot around the two or more elongated objects. The method comprises detecting S1 a blank fire condition by the control unit 170 in case no elongated objects are enclosed by the wire 210 fed out from the wire feed mechanism 110 and held by the wire receiver mechanism 120, and in response to detecting a blank fire condition, controlling S2 the wire receiver mechanism 120, by the control unit 170, to release the held wire 210 and controlling S3 the wire feed mechanism 110, by the control unit 170, to retract the fed-out length of wire 210.

FIG. 17 schematically illustrates, in terms of a number of functional units, the general components of a control unit 170, 1700. Processing circuitry 1710 is provided using any combination of one or more of a suitable central processing unit CPU, multiprocessor, microcontroller, digital signal processor DSP, etc., capable of executing software instructions stored in a computer program product, e.g. in the form of a storage medium 1730. The processing circuitry 1710 may further be provided as at least one application specific integrated circuit ASIC, or field programmable gate array FPGA.

Particularly, the processing circuitry 1710 is configured to cause the device 100 to perform a set of operations, or steps, such as the methods discussed in connection to FIGS. 15-16 and the discussions above. For example, the storage medium 1730 may store the set of operations, and the processing circuitry 1710 may be configured to retrieve the set of operations from the storage medium 1730 to cause the device to perform the set of operations. The set of operations may be provided as a set of executable instructions. Thus, the processing circuitry 1710 is thereby arranged to execute methods as herein disclosed.

The storage medium 1730 may also comprise persistent storage, which, for example, can be any single one or combination of magnetic memory, optical memory, solid state memory or even remotely mounted memory.

The device 1700 may further comprise an interface 1720 for communications with at least one external device. As such the interface 1720 may comprise one or more transmitters and receivers, comprising analogue and digital components and a suitable number of ports for wireline or wireless communication.

The processing circuitry 1710 controls the general operation of the control unit 1700, e.g., by sending data and control signals to the interface 1720 and the storage medium 1730, by receiving data and reports from the interface 1720, and by retrieving data and instructions from the storage medium 1730.

The control unit 170, 1700 may be configured to perform all of the functions discussed above, e.g., in relation to controlling tilt angles and the like to move the machines in relation to a concrete surface.

There is also disclosed herein a computer readable medium carrying a computer program comprising program code means for performing the methods illustrated in FIGS. 15-16 and discussed herein, when said program product is run on a computer. The computer readable medium and the code means may together form a computer program product.

1. A wire tying device comprising a wire feed mechanism arranged to feed out a length of wire around two or more elongated objects, a wire receiver mechanism arranged to receive and to hold the fed-out wire, and a control unit arranged to control the wire feed mechanism and the wire receiver mechanism to tie a wire knot around the two or more elongated objects,
wherein the control unit is arranged to detect a blank fire condition in case no elongated objects are enclosed by the wire fed out from the wire feed mechanism and held by the wire receiver mechanism,
wherein the control unit, in response to detecting a blank fire condition, is arranged to control the wire receiver mechanism to release the held wire and to control the wire feed mechanism to retract the fed-out length of wire.

2. The wire tying device according to claim 1, wherein the control unit is arranged to control the wire feed mechanism to tighten the wire held by the receiver mechanism by retracting the wire, where the control unit is arranged to determine a fed-out length of wire and a retracted length of wire, and to detect the blank fire condition based at least in part on the determined fed-out length of wire and on the determined retracted length of wire.

3. The wire tying device according to claim 1, wherein the control unit is arranged to detect the blank fire condition based at least in part on an output signal from a proximity sensor, the proximity sensor comprising any of; a mechanical switch, a capacitive proximity sensor, an electromagnetic proximity sensor, a vision-based proximity sensor, and an electrical conductance sensor.

4. The wire tying device according to claim 1, comprising a wire feed sensor, the wire feed sensor comprising a measuring device, where the wire feed sensor is arranged to monitor a length of wire fed out and/or retracted by the wire feed mechanism by the measuring device.

5. The wire tying device according to any previous claim 1, wherein the control unit is arranged to determine a length of wire fed out and/or retracted by the wire feed mechanism based on a control signal sent to a wire feed motor of the wire tying device.

6. The wire tying device according to claim 1, comprising a wire end detection sensor arranged in connection to the wire feed mechanism, wherein the control unit is arranged to detect an end of the wire being retracted into the wire feed mechanism based on an output signal from the wire end detection sensor.

7. The wire tying device according to claim 1, wherein the control unit is arranged to measure the fed-out length of wire using a combination of a wire feed motor activation signal and a timer.

8. The wire tying device according to claim 1, wherein the control unit is arranged to monitor a number of consecutive blank fire condition events, and to cut the fed-out wire after a pre-determined number of consecutive blank fire condition events.

9. The wire tying device-according to claim 1, wherein the control unit is arranged to monitor a number of consecutive blank fire condition events, and to trigger generation of an error signal if the number of consecutive blank fire condition events exceeds a pre-determined number of consecutive blank fire condition events.

10. The wire tying device according to claim 9, comprising a solenoid device arranged to control a wire locking mechanism, wherein the control unit is arranged to repeatedly actuate the solenoid in response to a generated error signal by the control unit.

11. The wire tying device according to claim 9, wherein the control unit is arranged to generate the error signal as a wireless signal sent to an external control unit, as a wireline signal to an external control unit, as a buzzer signal, and/or as a vision-based notification signal.

12. The wire tying device according to claim 1, wherein the control unit is arranged to monitor a number of blank fire condition events and a number of successful wire knot tying events, and store the monitored number of blank fire condition events and the number of successful wire knot tying events in a storage medium of the wire tying device.

13. The wire tying device according to claim 1, wherein the two or more elongated objects are reinforcement bars, rebars, and the wire tying device is a rebar wire tying device.

14. A method performed by a control unit in a wire tying device, wherein the wire tying device comprises a wire feed mechanism arranged to feed out a length of wire around two or more elongated objects, a wire receiver mechanism arranged to receive and to hold the fed-out wire, and a control unit arranged to control the wire feed mechanism and the wire receiver mechanism to tie a wire knot around the two or more elongated objects, the method comprising
detecting a blank fire condition by the control unit in case no elongated objects are enclosed by the wire fed out from the wire feed mechanism and held by the wire receiver mechanism, and
in response to detecting a blank fire condition,
controlling the wire receiver mechanism, by the control unit, to release the held wire and
controlling the wire feed mechanism, by the control unit, to retract the fed-out length of wire.

15. A computer program comprising program code means for performing the method of claim 14 when said program is run on a computer or on processing circuitry of a control unit.
